(19) United States
(12) Patent Application Publication
(10) Pub. No.: US 2024/0267724 A1
(43) Pub. Date: Aug. 8, 2024

(54) COMMUNICATION METHOD AND COMMUNICATION APPARATUS

(71) Applicant: GUANGDONG OPPO MOBILE TELECOMMUNICATIONS CORP., LTD., Dongguan (CN)

(72) Inventor: Jiangsheng FAN, Dongguan (CN)

(73) Assignee: GUANGDONG OPPO MOBILE TELECOMMUNICATIONS CORP., LTD., Dongguan (CN)

(21) Appl. No.: 18/596,570

(22) Filed: Mar. 5, 2024

Related U.S. Application Data
(63) Continuation of application No. PCT/CN2021/129652, filed on Nov. 9, 2021.

(51) Int. Cl. H04W 8/22; H04W 52/36; H04W 72/21; H04W 76/20

(52) U.S. Cl. CPC H04W 8/22; H04W 52/367; H04W 72/21; H04W 76/20

(57) ABSTRACT

A communication method and a communication apparatus are provided. The communication method includes: a terminal device sends a first message. The first message is used for the terminal device to perform capability negotiation with a network device. The communication apparatus includes a memory and a processor, and the processor is configured to perform the communication method.

### CROSS-REFERENCE TO RELATED APPLICATION

The present disclosure is a US continuation application of International Application No. PCT/CN2021/129652 filed on Nov. 9, 2021. The disclosure of the above application is hereby incorporated by reference in its entirety.

### BACKGROUND

With the development of communication technology, some communication systems introduce the sharing of resources (for example, hardware resources of terminal device) among multiple subscriber identity module (SIM) cards to realize the receiving and transmitting of services of the multiple SIM cards through a set of terminal devices. However, it is not clear at present how to share the resources of the terminal device among multiple SIM cards.

### SUMMARY

The present disclosure relates to the field of communication technology and, more particularly, to a communication method and a communication apparatus. The present disclosure provides a communication method and a communication apparatus, which can flexibly control resources of the terminal device.

In the first aspect, a communication method is provided. The method includes a terminal device transmitting the first message. The first message is used for a capability negotiation performed by the terminal device with a network device.

In the second aspect, a communication method is provided. The method includes a network device receiving the first message. The first message is used for a capability negotiation performed by a terminal device with the network device.

In the third aspect, a communication apparatus is provided. The apparatus includes a transmitting unit configured to transmit the first message. The first message is used for a capability negotiation performed by the apparatus with a network device.

In the fourth aspect, a communication apparatus is provided. The apparatus includes a receiving unit configured to receive the first message. The first message is used for a capability negotiation performed by a terminal device with the apparatus.

In the fifth aspect, a communication device is provided. The communication device includes a memory and a processor. The memory is configured to store programs, and the processor is configured to invoke the programs in the memory to perform the method as described in the first aspect.

In the sixth aspect, a communication device is provided. The communication device includes a memory and a processor. The memory is configured to store programs, and the processor is configured to invoke the programs in the memory to perform the method as described in the second aspect.

In the seventh aspect, a communication device is provided. The communication device includes a processor for invoking programs from a memory to perform the method as described in the first aspect.

In the eighth aspect, a communication device is provided. The communication device includes a processor for invoking programs from a memory to perform the method as described in the second aspect.

In the ninth aspect, a chip is provided. The chip includes a processor for invoking programs from a memory to cause a device in which the chip is installed to perform the method as described in the first aspect.

In the tenth aspect, a chip is provided. The chip includes a processor for invoking programs from a memory to cause a device in which the chip is installed to perform the method as described in the second aspect.

In the eleventh aspect, a computer readable storage medium having a program stored thereon is provided. The program causes a computer to perform the method as described in the first aspect.

In the twelfth aspect, a computer readable storage medium having a program stored thereon is provided. The program causes a computer to perform the method as described in the second aspect.

In the thirteenth aspect, a computer program product including programs is provided. The programs cause a computer to perform the method as described in the first aspect.

In the fourteenth aspect, a computer program product including programs is provided. The programs cause a computer to perform the method as described in the second aspect.

In the fifteenth aspect, a computer program is provided. The computer program cause a computer to perform the method as described in the first aspect.

In the sixteenth aspect, a computer program is provided. The computer program cause a computer to perform the method as described in the second aspect.

### BRIEF DESCRIPTION OF THE DRAWINGS

FIG. 1 is an example diagram of a wireless communication system applied in the embodiments of the present disclosure.

FIG. 2 is a schematic flowchart of a communication method provided by an embodiment of the present disclosure.

FIG. 3 is a schematic diagram of a structure of a communication apparatus provided by an embodiment of the present disclosure.

FIG. 4 is a schematic diagram of a structure of a communication apparatus provided by another embodiment of the present disclosure.

FIG. 5 is a schematic diagram of a structure of a device provided by an embodiment of the present disclosure.

### DETAILED DESCRIPTION

The technical solutions in the present disclosure will be described below in combination with the accompanying drawings.

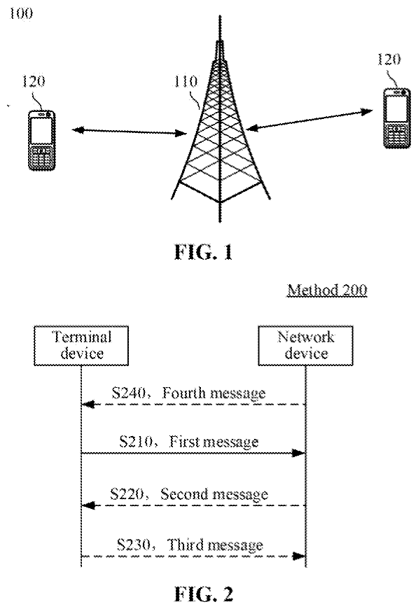

FIG. 1 is a wireless communication system 100 applied in the embodiments of the present disclosure. The wireless communication system 100 may include a network device 110 and user equipment (UE) 120. The network device 110 may communicate with the UE 120. The network device 110 may provide communication coverage for a specific geographical area, and may communicate with the UE 120 located in the coverage area. The UE 120 may be accessed to the network (such as wireless network) through the network device 110.

FIG. 1 illustrates a network device and two UEs exemplarily. Alternatively, the wireless communication system 100 may include multiple network devices and each network device may include other number of terminal devices within its coverage area, which is not limited in the embodiments of the present disclosure. Alternatively, the wireless communication system 100 may further include a network controller, a mobile management entity and other network entities, which is not limited in the embodiments of the present disclosure.

It should be understood that the technical solutions of the embodiments of the present disclosure may be applied to various communication systems, such as, a 5th generation (5G) system or a new radio (NR), a long term evolution (LTE) system, a LTE frequency division duplex (FDD) system, a LTE time division duplex (TDD) system, etc. The technical solutions provided in the present disclosure may also be applied to future communication systems, such as a sixth generation mobile communication system, a satellite communication system, etc.

The UE in the embodiments of the present disclosure may also be referred to as a terminal device, an access terminal, a user unit, a user station, a mobile station, a mobile station (MS), a mobile terminal (MT), a remote station, a remote terminal, a mobile device, a user terminal, a terminal, a wireless communication device, a user agent or a user device. The UE in the embodiments of the present disclosure may be a device that provides voice and/or data connectivity to the user, and may be used to connect people, objects and machines, such as a handheld device with wireless connection function, an on-board device, etc. The UE in the embodiments of the present disclosure may be a mobile phone, a pad, a laptop, a handheld computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, etc. Alternatively, the UE may be used as a base station. For example, the UE may act as a scheduling entity, which provides sidelink signals between UEs in V2X or D2D, etc. For example, a cellular phone and a car use the sidelink signals to communicate with each other, and a cellular phone communicates with a smart home device, without relaying communication signals through the base station.

The network device in the embodiments of the present disclosure may be a device used to communicate with the UE. The network device may also be referred to as an access network device or a wireless access network device, for example, the network device may be a base station. The network device in the embodiments of the present disclosure may refer to a radio access network (RAN) node (or device) that accesses the UE to the wireless network. The base station may broadly cover or replace the following names, such as a Node B, an evolved NodeB (eNB), a next generation NodeB (gNB), a relay station, an access point, a transmitting and receiving point (TRP), a transmitting point (TP), a Master station (MeNB), an Secondary station (SeNB), an Multi standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, etc. The base station may be a macro base station, a micro base station, a relay node, a donor node or the like, or a combination thereof.

In some embodiments, the network device may be fixed or mobile. For example, a helicopter or an unmanned aerial vehicle may be configured to act as a mobile network device, and one or more cells may move according to the positions of the mobile network device. In other examples, a helicopter or an unmanned aerial vehicle may be configured as a device for communicating with another network device. In some embodiments, the network device may refer to a CU or a DU, or the network device may include the CU and the DU, or the network device may also include an AAU.

It should be understood that the network device may be deployed on land, which includes an indoor device or an outdoor device, a handheld device or a vehicle-mounted device. The network device may be deployed on water. The network device may be deployed in the air, such as on an airplane, a balloon, or a satellite. The network device and the scenarios in which it is deployed are not limited in embodiments of the present disclosure.

It should also be understood that all or part of the functions of the network device and the UE in the present disclosure may also be realized by software functions running on hardware, or by virtualization functions instantiated on platforms (such as cloud platforms).

With the development of the communication technology, multi-card terminal device(s) have been introduced in some communication systems. Two or more SIM cards may be contained in a multi-card terminal device. In some cases, all (or almost all) resources of the terminal device may be used by one of the SIM cards. For example, the terminal device may contain two SIM cards. The SIM card A is in the connected state and the SIM card 2 is in the idle state or the inactive state. In some cases, the resources of the terminal device may be shared by the multiple SIM cards (or a part of the resources of the terminal device is respectively used by each SIM card). For example, the terminal device may include two SIM cards. The SIM card A and the SIM card B are both in the connected state. However, at present, it is still unclear how to share the resources of the terminal device among the multiple SIM cards to achieve rational utilization of resources.

In the embodiments of the present disclosure, the terminal device performs the capability negotiation with the network device through the first message, which can flexibly control the resources of the terminal device, enhance the flexibility of resource utilization of the terminal device, and thus improve the user experience of the terminal device.

In order to solve the above technical problems, the embodiments of the present disclosure are exemplarily described in detail below in combination with FIG. 2.

FIG. 2 is a schematic flowchart of a communication method provided by an embodiment of the present disclosure. The method 200 illustrated in FIG. 2 may include the following operations S210 and S220.

In operation S210, a terminal device transmits the first message to a network device.

The terminal device may be a multi-card terminal device or a single-card terminal device. Alternatively, multiple SIM cards of the multi-card terminal device may be SIM cards in a same communication system or SIM cards in different communication systems. Alternatively, multiple SIM cards of multi-card terminal device may be SIM cards belonging to the same operator or SIM cards belonging to different operators.

For the convenience of description, in the subsequent embodiments, the multi-card terminal device only contains two SIM cards (card A and card B) as an example.

The first message may be used for capability negotiation performed by the terminal device with the network device. Alternatively, the first message may indicate that the terminal device expects the network device to retain a part of resources of the terminal device, and/or the first message may indicate that the terminal device expects the network device to release resources of the terminal device. Alternatively, the first message may be of any one of the following message types: radio resource control (RRC) message, media access control control element (MAC CE) message, or uplink control information (UCI) message.

For example, the terminal device is a multi-card terminal device or a single-card terminal device. If the power consumption of the terminal device is too great or the heat generation of the terminal device is too high, the terminal device may transmit the first message to the network device to request the network device to release the resources of the terminal device, so as to reduce the power consumption or heat generation of the terminal device. Alternatively, the terminal device is a multi-card terminal device, and the card A is in the connected state and the card B is in the idle state. If the card B needs to enter the connected state, the terminal device may transmit the first message to the network device through the card A to request the network device to release the resources of the terminal device for use by the card B (when entering the connected state).

In the embodiment of the present disclosure, the resources of the terminal device may include hardware resources and/or software resources of the terminal device. The hardware resources may include resources such as transmitting antennas of the terminal device, receiving antennas of the terminal device, carriers supported by the terminal device, power amplifiers supported by the terminal device, and so on. The software resources may include resources such as digital modems, encoders, digital filters, and so on.

In the embodiment of the present disclosure, the terminal device may directly transmit its desired resource usage demand or capability configuration to the network device.

The first message may include at least one of the following: the number of transmitting antennas expected to be retained by the terminal device, the number of receiving antennas expected to be retained by the terminal device, the number of transmitting antennas expected to be released by the terminal device, the number of receiving antennas expected to be released by the terminal device, the maximum number of carriers expected to be supported by the terminal device, or the maximum transmit power expected to be supported by the terminal device.

Alternatively, the first message may indicate that the terminal device expects the network device to release a part or all of resources of the terminal device.

In one implementation, the first message may indicate that the terminal device expects the network device to release a part of resources of the terminal device to ensure the minimum service demand of the terminal device. Accordingly, the network device may retain the resources required by the terminal device to perform the minimum essential service after receiving the first message. For example, when the card B has a service and the terminal device is triggered to request the network device to release a part of resources, if the card A is in the connected state, the network device needs to retain at least one transmitting antenna and at least one receiving antenna for the card A to maintain the minimum essential communication, so as to avoid a long-term interruption of the service of the card A.

In another implementation, the first message may indicate that the terminal device expects the network device to release all resources of the terminal device. For example, after receiving the first message, the network device may choose to release all resources of the terminal device, that is, the card A is released from the connected state to the idle state or inactive state.

Alternatively, the first message may include a capability configuration requested by the terminal device from the network device. Alternatively, the capability configuration requested by the terminal device from the network device is usually “temporary”, so the capability configuration may also be referred to as the temporary capability configuration. For example, the terminal device is a multi-card terminal device, and the card A is in the connected state and the card B is in the idle state. If the card B needs to enter the connected state temporarily for data transmission, the terminal device may request temporary capability configuration from the network device through the card A for use by the card B. For the convenience of description, it will be uniformly referred to as the capability configuration in subsequent embodiments.

Alternatively, the capability configuration may include at least one of the following: a number of transmitting antennas of the terminal device, a number of receiving antennas of the terminal device, a maximum number of carriers supported by the terminal device, a maximum bandwidth supported by the terminal device, a dual connectivity (DC) capability of the terminal device, a carrier aggregation (CA) capability of the terminal device, a maximum number of multi input multi output (MIMO) system layers supported by the terminal device, or a maximum transmit power supported by the terminal device.

The maximum bandwidth supported by the terminal device may be defined for different frequency ranges (FR) (for example, FR1, FR2-1, and FR2-2), and the maximum bandwidth supported within a FR may be further defined separately according to uplink and downlink. For the maximum number of MIMO layers supported by the terminal device, the supported maximum number of MIMO layers may be defined for different FRs (for example, FR1, FR2-1, and FR2-2) respectively, and the maximum number of MIMO layers supported within a FR may be further defined separately according to uplink and downlink. The maximum number of carriers supported by the terminal device may be defined for different FRs (for example, FR1, FR2-1, and FR2-2).

In the embodiment of the present disclosure, the terminal device may transmit a preset value to the network device. The different preset values may correspond to different resource usage demands or different capability configurations, respectively.

Alternatively, the first message may include the first preset value. The first preset value may correspond to a kind of resource usage demand of the terminal device.

In one implementation, the first preset value may include one or more bits, and the resource usage demand corresponding to each of the values may be specified through protocol or pre-configuration.

For example, the first preset value may include two bits, the value range of which may be {00, 01, 10, 11}, and the resource usage demand corresponding to each of these values may be specified through the protocol, the specific details are as follows.

The resource usage demand corresponding to value ‘00’ is retaining at least one transmitting antenna and at least one receiving antenna.

The resource usage demand corresponding to value ‘01’ is releasing a part of resources of the terminal device.

The resource usage demand corresponding to value ‘10’ is that other SIM card(s) needs to use a part of resources of the terminal device.

The value ‘11’ is reserved and is not used temporarily.

Alternatively, the first message may include the second preset value. The second preset value may correspond to a set of capability configurations of the terminal device.

In another implementation, the second preset value may include one or more bits, and the resource usage demand corresponding to each of the values may be specified through protocol or pre-configuration.

For example, the second preset value may include two bits, the value range of which may be {00, 01, 10, 11}, and the set of capability configurations corresponding to each of these values may be specified through the protocol, the specific details are as follows.

The value ‘00’ corresponds to the first set of capability configurations of the terminal device.

The value ‘01’ corresponds to the second set of capability configurations of the terminal device.

The value ‘10’ corresponds to the third set of capability configurations of the terminal device.

The value ‘11’ is reserved and is not used temporarily.

Alternatively, the first message may further include reason information for the terminal device to perform the capability negotiation with the network device and/or first time window configuration information in which the terminal device expects content requested in the first message to take effect.

The reason information may indicate the reason why the terminal device expects the network device to retain a part of resources of the terminal device, and/or, the reason information may indicate the reason why the terminal device expects the network device to release a part of or all of resources of the terminal device. For example, the reason information may include the service need of other SIM card(s), t other SIM card(s) needs to receive paging, other SIM card(s) needs to receive system broadcast message update, other SIM card(s) needs to measure, other SIM card(s) needs to request a system broadcast message, and other SIM card(s) needs to enter the connected state.

The first time window configuration information may be used to inform the network device of a desired effective time of the requested content contained in the first message. For example, within the time range corresponding to the first time window configuration, the requested content contained in the first message is valid, and outside the time range corresponding to the first time window configuration, the requested content contained in the first message is invalid.

For example, if the periodic paging service of the card B causes a receiving antenna originally serving the card A to serve the card B, with the first time window configuration information, a receiving antenna may be given by the card A to the card B within the time range corresponding to the first time window configuration information to help the card B to complete paging monitoring, and the given receiving antenna is retrieved outside the time range corresponding to the first time window configuration information, so as to enable the card A to use multiple receiving antennas to receive data, avoid the long-term decline of the performance of the card A, and ensure the throughput of the service of the card A while ensuring the service of the card B.

Alternatively, the first time window configuration information may be a periodic time window. The periodic time window may include a start point offset configuration of the time window, a length configuration of the time window, and a repetition period configuration of the time window. Alternatively, the first time window configuration information may be a non-periodic time window. The non-periodic time window may include a start point configuration of the time window and a length configuration of the time window.

In the embodiment of the present disclosure, the terminal device may transmit its desired resource usage demand or capability configuration to the network device through an uplink sequence.

When the uplink sequence is used to indicate the resource usage demand or capability configuration, the resource usage demand or capability configuration indicated by the uplink sequence may be determined through the information such as the waveform of the uplink sequence. It is not needed that the data packet is further submitted to the high layer (such as the RRC layer). Therefore, communication efficiency can be improved. For example, the uplink sequence may be a preamble or other uplink sequence.

Alternatively, the first message may be the first uplink sequence. The first uplink sequence may indicate that the terminal device expects the network device to degrade or roll back a part of a capability configuration of the terminal device.

The first uplink sequence may be configured through at least one of the following manners: pre-configuration, system broadcast message configuration, or dedicated signaling configuration. For example, a kind of resource usage demand or capability configuration indicated by the waveform corresponding to the first uplink sequence may be configured in advance through the pre-configuration.

In the embodiment of the present disclosure, the terminal device may transmit an uplink sequence among multiple uplink sequences to the network device. The different uplink sequences may correspond to different resource usage demands or different capability configurations, respectively.

Alternatively, the first message may be the second uplink sequence, and the second uplink sequence may be one of multiple uplink sequences. The multiple uplink sequences may correspond to multiple kinds of different resource usage demands or multiple kinds of different capability configurations, respectively. The second uplink sequence may indicate a kind of resource usage demand (among the multiple kinds of different resource usage demands). Alternatively, the second uplink sequence may indicate a kind of capability configuration (among the multiple kinds of different capability configurations).

Alternatively, the second uplink sequence may be configured through at least one of the following manners: pre-configuration manner, system broadcast message configuration manner, or dedicated signaling configuration manner. For example, multiple kinds of resource usage demands or capability configurations indicated by waveforms corresponding to multiple uplink sequences (including the second uplink sequence) may be configured in advance through a manner of pre-configuration.

In one implementation, the first message may correspond to four kinds of uplink sequences (the second uplink sequence is one of these four kinds of uplink sequences). A kind of resource usage demand corresponding to each uplink sequence may be specified through the protocol, as follows.

The resource usage demand corresponding to the uplink sequence 1 is retaining at least one transmitting antenna and at least one receiving antenna.

The resource usage demand corresponding to the uplink sequence 2 is releasing a part of resources of the terminal device.

The resource usage demand corresponding to the uplink sequence 3 is that other SIM card(s) needs to use a part of resources of the terminal device.

The uplink sequence 4 is reserved and is not used temporarily.

In another implementation, the first message may correspond to four kinds of uplink sequences (the second uplink sequence is one of these four kinds of uplink sequences). A set of capability configurations corresponding to each kind of uplink sequence may be specified through the protocol, as follows.

The uplink sequence 1 corresponds to the first set of temporary capability of the terminal device.

The uplink sequence 2 corresponds to the second set of temporary capability of the terminal device.

The uplink sequence 3 corresponds to the third set of temporary capability of the terminal device.

The uplink sequence 4 is reserved and is not used temporarily.

In the embodiment of the present disclosure, the terminal device performs capability negotiation with the network device through the first message, which can flexibly control the resources of the terminal device, enhance the flexibility of resource utilization of the terminal device, and thus improve the user experience of the terminal device.

In the embodiment of the present disclosure, the network device may transmit a response message (for example, the second message) of the first message to the terminal device. For example, the method 200 may further include the following operation 220.

In operation S220, the network device transmits the second message to the terminal device.

In one implementation, after the terminal device transmits the first message, the network device may transmit the second message to the terminal device.

Alternatively, the second message may include a capability configuration determined by the network device for the terminal device and/or indication information that content requested in the first message is accepted by the network device.

The capability configuration determined by the network device for the terminal device may indicate that all of the content requested by the terminal device in the first message is accepted by the network device. For example, the terminal device transmits the first message to the network device, and the first message is used to request the network device for the terminal device to retain two transmitting antennas and two receiving antennas. At this case, the capability configuration determined by the network device for the terminal device may include two transmitting antennas and two receiving antennas.

Alternatively, the capability configuration determined by the network device for the terminal device may indicate that a part of the content requested by the terminal device in the first message is accepted by the network device. For example, the terminal device transmits the first message to the network device, and the first message is used to request the network device to retain two transmitting antennas and two receiving antennas for the terminal device, at this case, the capability configuration determined by the network device for the terminal device may only include two transmitting antennas.

Alternatively, the capability configuration determined by the network device for the terminal device may indicate the capability configuration re-determined by the network device for the terminal device (at this case, the content requested by the terminal device in the first message is not accepted by the network device). For example, the terminal device transmits the first message to the network device, and the first message is used to request the network device to retain two transmitting antennas and two receiving antennas for the terminal device. At this case, the capability configuration determined by the network device for the terminal device may include that the maximum number of MIMO layers supported by the terminal device is 4 layers.

Alternatively, the second message may further include second time window configuration information in which the capability configuration is taken effect.

In one implementation, the second message is used to confirm that all the requested content contained in first message is accepted, and the second time window configuration information may be used to inform the terminal device of the effective time of the requested content contained in the first message. For example, within the time range corresponding to the second time window configuration, the requested content contained in the first message is valid, and outside the time range corresponding to the second time window configuration, the requested content contained in the first message is invalid.

In another implementation, the second message is used to inform the terminal device of the result of the capability negotiation, and the second time window configuration information may be used to inform the terminal device of the effective time of the capability configuration contained in the second message. For example, within the time range corresponding to the second time window configuration, the capability configuration contained in the second message is valid, and outside the time range corresponding to the second time window configuration, the capability configuration contained in the second message is invalid.

For example, if the periodic paging service of the card B causes a receiving antenna originally serving the card A to serve the card B, with the second time window configuration information, a receiving antenna may be given by the card A to the card B within the time range corresponding to the second time window configuration information to help the card B to complete paging monitoring, and the given receiving antenna is retrieved outside the time range corresponding to the second time window configuration information, so as to enable the card A to use multiple receiving antennas to receive data, avoid the long-term decline of the performance of the card A, and ensure the throughput of the service of the card A while ensuring the service of the card B.

Alternatively, the second time window configuration information may be a periodic time window. The periodic time window may include a start point offset configuration of the time window, a length configuration of the time window, and a repetition period configuration of the time window. Alternatively, the second time window configuration information may be a non-periodic time window. The non-periodic time window may include a start point configuration of the time window and a length configuration of the time window.

Alternatively, the second message may be any of the following message types: RRC message, radio link control (RLC) packet data unit (PDU) message, MAC CE message, or downlink control information (DCI) message.

In another implementation, after the terminal device transmits the first message, if the terminal device has not received the second message within a preset time period, the terminal device may autonomously determine a set of capability configurations. In this way, it can be avoided that the service of the card B cannot be performed or the service is interrupted for a long time because the network device does not transmit the response message (for example, the second message) in time or the terminal device does not receive the response message transmitted by the network device in time, so that the execution of the service can be flexible.

Alternatively, the preset time period may be configured through at least one of the following manners: pre-configuration, system broadcast message configuration and dedicated signaling configuration.

In the embodiment of the present disclosure, the terminal device may request the network device to cancel the previously transmitted request (for example, the third message). For example, the method 200 may include the following operation S230.

In operation S230, the terminal device transmits the third message to the network device.

The third message may be a cancel instruction that may indicate that the terminal device expects to cancel the previously transmitted capability negotiation request.

Alternatively, the third message may be used to request the network device to cancel the previously accepted capability negotiation request of the terminal device, or the third message may be used to request the network device to cancel the content requested in the first message.

Alternatively, the third message may indicate that the terminal device requests the network device to restore a capability configuration before the capability negotiation, or the third message may be used to indicate the network device that a use of a capability configuration of the terminal device is unrestricted.

Alternatively, the third message is associated with time point configuration information, expected by the terminal device, at which a cancel instruction (for example, the third message) is taken effect. In this way, the effective time of the cancel request is delayed, so as to facilitate the network device to arrange resource management and scheduling policies in advance.

Alternatively, the time point configuration information at which the cancel instruction is taken effect may be determined through protocol by default.

For example, it may be specified by the protocol that the first slot of a next radio frame after the network device successfully receives the third message is the start time point for the cancel instruction to take effect.

Alternatively, the time point configuration information at which the cancel instruction is taken effect may be reported to the network device through the third message.

For example, the time point configuration information at which the cancel instruction is taken effect may be contained in the third message. The time point configuration information at which the cancel instruction is taken effect may be in any of the following forms: coordinated universal time (UTC) time (at which the cancel instruction is taken effect), a frame number and an sub-frame number (at which the cancel instruction is taken effect), or a frame number and a slot number (at which the cancel instruction is taken effect).

Alternatively, the third message may be of any one of the following message types: RRC message, MAC CE message, UCI message, or uplink sequence.

In the case that the third message is the uplink sequence, the uplink sequence itself may indicate the meaning of the cancel instruction. If the time point configuration at which the cancel instruction is taken effect exists, the time point configuration at which the cancel instruction is taken effect may be specified by a protocol or pre-configured. For example, it may be specified by the protocol that the first slot of the next radio frame after the third message is successfully received is the start time point for the cancel instruction to take effect.

In the embodiment of the present disclosure, the network device may further transmit indication information (for example, the fourth message) to the terminal device to indicate whether the terminal device is allowed to perform the capability negotiation. For example, the method 200 may further include the following operation S240.

In operation S240, the network device transmits the fourth message to the terminal device.

The fourth message may indicate that the network device allows the terminal device to perform the capability negotiation. For example, in a case that the value of the fourth message indicates that the network device allows the terminal device to perform the capability negotiation, the terminal device is allowed to request the network device for the capability negotiation through the first message. Otherwise, in a case that the value of the fourth message indicates that the network device does not allow the terminal device for the capability negotiation, the terminal device is not allowed to request the network device to perform the capability negotiation through the first message.

Alternatively, the fourth message may further include a configuration of a timer for prohibiting frequent request, and the terminal device is not allowed to request the network device for the capability negotiation through the first message during an operation of the timer for prohibiting frequent request. By means of the timer for prohibiting frequent request, the problem of excessive uplink signaling overhead caused by the terminal device frequently requesting the network device for capability negotiation can be avoided.

For example, during the operation of the timer for prohibiting frequent request, even if the value of the fourth message indicates allowing (for example, if the value of the fourth message indicates that the terminal device is allowed to request the network device for the capability negotiation through the first message), the terminal device is not allowed to request the network device for the capability negotiation through the first message.

Through the methods in the embodiments of the present disclosure, the resources of the multi-card terminal device can be flexibly shared among multiple SIM cards, which can not only meet the different services needs of multiple SIM cards, but also greatly avoid the interruption of services of cards, thus improving the user experience of the multi-card terminal device.

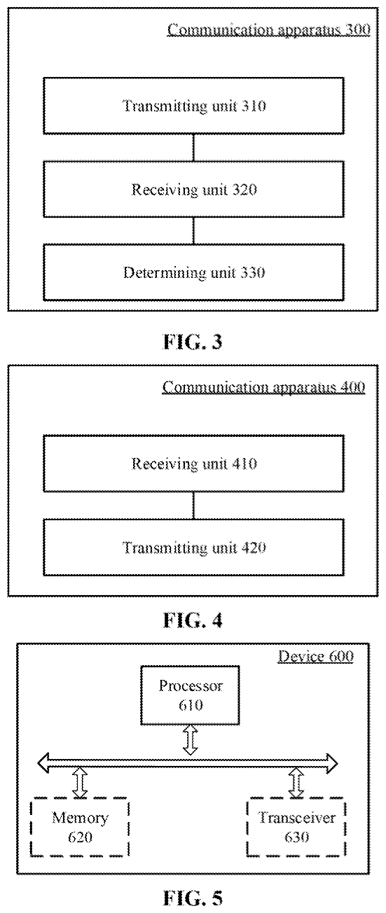

The method embodiments of the present disclosure are described in detail above in combination with FIG. 1 and FIG. 2, and the apparatus embodiments of the present disclosure are described in detail below in combination with FIG. 3 to FIG. 5. It should be understood that the description of the method embodiments and the description of the apparatus embodiments correspond to each other, and therefore, the part which is not described in detail may refer to the previous method embodiments.

FIG. 3 is a schematic diagram of a structure of a communication apparatus provided by an embodiment of the present disclosure. As illustrated in FIG. 3, the apparatus 300 includes a transmitting unit 310.

The transmitting unit 310 is configured to transmit the first message. The first message is used for a capability negotiation performed by the apparatus with a network device.

Alternatively, the first message includes at least one of: a number of transmitting antennas expected to be retained by the apparatus, a number of receiving antennas expected to be retained by the apparatus, a number of transmitting antennas expected to be released by the apparatus, a number of receiving antennas expected to be released by the apparatus, a maximum number of carriers expected to be supported by the apparatus, or a maximum transmit power expected to be supported by the apparatus.

Alternatively, the first message indicates that the apparatus expects the network device to release a part or all of resources of the apparatus.

Alternatively, the first message includes a capability configuration requested by the apparatus from the network device.

Alternatively, the first message includes the first preset value, and the first preset value corresponds to a kind of resource usage demand of the apparatus.

Alternatively, the first message includes the second preset value, and the second preset value corresponds to a set of capability configurations of the apparatus.

Alternatively, the first message further includes reason information for the capability negotiation performed by the apparatus with the network device, and/or, the first time window configuration information in which the apparatus expects content requested in the first message to take effect.

Alternatively, the first time window configuration information is a periodic time window. The periodic time window includes a start point offset configuration of the time window, a length configuration of the time window, and a repetition period configuration of the time window. Alternatively, the first time window configuration information is a non-periodic time window. The non-periodic time window includes a start point configuration of the time window and a length configuration of the time window.

Alternatively, the first message is of any one of the following message types: RRC message, MAC CE message, or UCI message.

Alternatively, the first message is the first uplink sequence. The first uplink sequence is used for indicating that the apparatus expects the network device to degrade or roll back a part of capability configuration of the apparatus.

Alternatively, the first message is the second uplink sequence. The second uplink sequence is one of a plurality of uplink sequences. The second uplink sequence indicates a kind of resource usage demand of the apparatus, or the second uplink sequence indicates a kind of capability configuration of the apparatus.

Alternatively, the first uplink sequence or the second uplink sequence is configured through at least one of the following manners: pre-configuration, system broadcast message configuration or dedicated signaling configuration.

Alternatively, the apparatus 300 further includes a receiving unit 320 configured to receive the second message. The second message includes a capability configuration determined by the network device for the apparatus and/or indication information that content requested in the first message is accepted by the network device.

Alternatively, the apparatus 300 further include a receiving unit 320 and a determining unit 330. If the receiving unit has not received a second message within a preset time period, the determining unit is configured to autonomously determine a set of capability configurations. The second message includes a capability configuration determined by the network device for the apparatus and/or indication information that content requested in the first message is accepted by the network device.

Alternatively, the preset time period is configured through at least one of following manners: pre-configuration, system broadcast message configuration or dedicated signaling configuration.

Alternatively, the second message further includes second time window configuration information in which the capability configuration is taken effect.

Alternatively, the second time window configuration information is a periodic time window. The periodic time window includes a start point offset configuration of the time window, a length configuration of the time window, and a repetition period configuration of the time window. Alternatively, the second time window configuration information is a non-periodic time window. The non-periodic time window includes a start point configuration of the time window and a length configuration of the time window.

Alternatively, the second message is of any one of the following message types: RRC message, RLC PDU message, MAC CE message, or DCI message.

Alternatively, the capability configuration includes at least one of the following: a number of transmitting antennas of the apparatus, a number of receiving antennas of the apparatus, a maximum number of carriers supported by the apparatus, a maximum bandwidth supported by the apparatus, a DC capability of the apparatus, a CA capability of the apparatus, a maximum number of MIMO system layers supported by the apparatus, or a maximum transmit power supported by the apparatus.

Alternatively, the transmitting unit 310 is further configured to transmit the third message. The third message is used for indicating that the apparatus requests the network device to restore a capability configuration before capability negotiation, or the third message is used by the apparatus to indicate the network device that a use of a capability configuration is unrestricted.

Alternatively, the third message is associated with time point configuration information, expected by the apparatus, at which a cancel instruction is taken effect.

Alternatively, the time point configuration information at which the cancel instruction is taken effect is determined through a protocol by default, or the time point configuration information at which the cancel instruction is taken effect is reported through the third message.

In case that the time point configuration information at which the cancel instruction is taken effect is reported through the third message, the time point configuration information at which the cancel instruction is taken effect is in any one of following forms: a UTC time, a frame number and an sub-frame number or a frame number and a slot number.

Alternatively, the third message is of any one of following message types: RRC message, MAC CE message, UCI message, or uplink sequence.

Alternatively, the apparatus 300 further includes a receiving unit 320 configured to receive the fourth message. The fourth message is used for indicating that the network device allows the apparatus to perform the capability negotiation.

Alternatively, the fourth message further includes a configuration of a timer for prohibiting frequent request. The apparatus is not allowed to request the network device for the capability negotiation through the first message during an operation of the timer for prohibiting the frequent request.

FIG. 4 is a schematic diagram of a structure of a communication apparatus provided by an embodiment of the present disclosure. The communication apparatus 400 in FIG. 4 includes a receiving unit 410.

The receiving unit 410 is configured to receive the first message. The first message is used for a capability negotiation performed by a terminal device with the apparatus.

Alternatively, the first message includes at least one of the following: a number of transmitting antennas expected to be retained by the terminal device, a number of receiving antennas expected to be retained by the terminal device, a number of transmitting antennas expected to be released by the terminal device, a number of receiving antennas expected to be released by the terminal device, a maximum number of carriers expected to be supported by the terminal device, or a maximum transmit power expected to be supported by the terminal device.

Alternatively, the first message indicates that the terminal device expects the apparatus to release a part or all of resources of the terminal device.

Alternatively, the first message includes a capability configuration requested by the terminal device from the apparatus.

Alternatively, the first message includes the first preset value, and the first preset value corresponds to a kind of resource usage demand of the terminal device.

Alternatively, the first message includes the second preset value, and the second preset value corresponds to a set of capability configurations of the terminal device.

Alternatively, the first message further includes reason information for the capability negotiation performed by the terminal device with the apparatus, and/or, first time window configuration information in which the terminal device expects content requested in the first message to take effect.

Alternatively, the first time window configuration information is a periodic time window. The periodic time window includes a start point offset configuration of the time window, a length configuration of the time window, and a repetition period configuration of the time window. Alternatively, the first time window configuration information is a non-periodic time window. The non-periodic time window includes a start point configuration of the time window and a length configuration of the time window.

Alternatively, the first message is of any one of the following message types: RRC message, MAC CE message, and UCI message.

Alternatively, the first message is the first uplink sequence. The first uplink sequence is used for indicating that the terminal device expects the apparatus to degrade or roll back a part of a capability configuration of the terminal device.

Alternatively, the first message is the second uplink sequence. The second uplink sequence is one of a plurality of uplink sequences. The second uplink sequence indicates a kind of resource usage demand of the terminal device, or the second uplink sequence indicates a kind of capability configuration of the terminal device.

Alternatively, the first uplink sequence or the second uplink sequence is configured through at least one of following manners: pre-configuration, system broadcast message configuration or dedicated signaling configuration.

Alternatively, the apparatus 400 further includes a transmitting unit 420 configured to transmit the second message. The second message includes a capability configuration determined by the apparatus for the terminal device and/or indication information that content requested in the first message is accepted by the apparatus.

Alternatively, the second message further includes the second time window configuration information in which the capability configuration is taken effect.

Alternatively, the second time window configuration information is a periodic time window. The periodic time window includes a start point offset configuration of the time window, a length configuration of the time window, and a repetition period configuration of the time window. Alternatively, the second time window configuration information is a non-periodic time window. The non-periodic time window includes a start point configuration of the time window and a length configuration of the time window.

Alternatively, the second message is of any one of the following message types: RRC message, RLC PDU message, MAC CE message or DCI message.

Alternatively, the capability configuration includes at least one of the following: a number of transmitting antennas of the terminal device, a number of receiving antennas of the terminal device, a maximum number of carriers supported by the terminal device, a maximum bandwidth supported by the terminal device, a dual connectivity (DC) capability of the terminal device, a carrier aggregation (CA) capability of the terminal device, a maximum number of multi input multi output (MIMO) system layers supported by the terminal device, or a maximum transmit power supported by the terminal device.

Alternatively, the receiving unit 410 is further configured to receive the third message. The third message is used for indicating that the terminal device requests the apparatus to restore a capability configuration before capability negotiation, or the third message is used by the terminal device to indicate the apparatus that a use of a capability configuration is unrestricted.

Alternatively, the third message is associated with time point configuration information, expected by the terminal device, at which a cancel instruction is taken effect.

Alternatively, the time point configuration information at which the cancel instruction is taken effect is determined through a protocol by default, or the time point configuration information at which the cancel instruction is taken effect is reported through the third message.

Alternatively, in case that the time point configuration information at which the cancel instruction is taken effect is reported through the third message, the time point configuration information at which the cancel instruction is taken effect is in any one of following forms: a UTC, a frame number and an sub-frame number, or a frame number and a slot number.

Alternatively, the third message is any one of the following message types: RRC message, MAC CE message, UCI message, or uplink sequence.

Alternatively, the apparatus 400 further includes a transmitting unit 420 configured to transmit the fourth message. The fourth message is used for indicating that the apparatus allows the terminal device to perform the capability negotiation.

Alternatively, the fourth message further includes a configuration of a timer for prohibiting frequent request. The terminal device is not allowed to request the apparatus for the capability negotiation through the first message during an operation of the timer for prohibiting the frequent request.

FIG. 5 is a schematic diagram of a structure of a device provided by an embodiment of the present disclosure. The dotted lines in FIG. 5 indicate that the units or modules are optional. The device 600 may be used to implement the methods described in the method embodiments above. The device 600 may be a chip or a communication device.

The device 600 may include one or more processors 610. The processor 610 may support the device 600 to implement the methods described in the above method embodiments. The processor 610 may be a general purpose processor or a special purpose processor. For example, the processor may be a central processing unit (CPU). Alternatively, the processor may be other general purpose processor, a digital signal processor (DSP), an application specific integrated circuit (ASIC), a field programmable gate array (FPGA) or other programmable logic device, a discrete gate or a transistor logic device, a discrete hardware component, etc. The general purpose processor may be a microprocessor or the processor may be any conventional processor, etc.

The device 600 may further include one or more memories 620. The programs are stored on the memory 620. The programs may be executed by the processor 610 to cause the processor 610 to perform the methods described in the above method embodiments. The memory 620 may be independent of the processor 610 or may be integrated into the processor 610.

The device 600 may further include a transceiver 630. The processor 610 may communicate with other devices or chips through the transceiver 630. For example, the processor 610 may transmit and receive data with other devices or chips through the transceiver 630.

The embodiment of the present disclosure further provides a computer readable storage medium for storing programs. The computer readable storage medium may be applied to the communication device provided in the embodiment of the present disclosure, and the programs cause the computer to perform methods performed by the communication device in embodiments of the present disclosure.

The embodiment of the present disclosure further provides a computer program product. The computer program product includes programs. The computer program product may be applied to a communication device provided in the embodiment of the present disclosure, and the programs cause the computer to perform the methods performed by the communication device in embodiments of the present disclosure.

The embodiment of the present disclosure further provides a computer program. The computer program may be applied to a communication device provided in the embodiment of the present disclosure, and the computer program causes the computer to perform the methods performed by the communication device in embodiments of the present disclosure.

It should be understood that in the embodiments of the present disclosure, “B corresponding to A” represents that B is associated with A, and B may be determined according to A. However, it should also be understood that determining B according to A does not mean determining B only according to A, but also determining B according to A and/or other information.

It should be understood that the term “and/or” in the present disclosure is only used for describing a kind of association relationship between the association objects, which indicates that there may be three kinds of relationships, for example, A and/or B, which indicates that there are three cases: A exists alone, both A and B exist, and B exists alone. In addition, the character “/” in the present disclosure generally indicates that there is an “or” relationship between the front and back associated objects.

It should be understood that, in various embodiments of the present disclosure, the size of the serial number of each of the above processes does not imply the order of execution, and the order of execution of each of the processes should be determined by its function and inherent logic, without constituting any limitation of the implementation processes of the embodiments of the present disclosure.

In the several embodiments provided in the present disclosure, it should be understood that the disclosed systems, devices and methods may be implemented in other ways. For example, the device embodiments described above are merely schematic. For example, the division of the units described is merely a logical functional division, and in the actual implementation, there may be other division manners. For example, multiple units or components may be combined or may be integrated into another system, or some features may be ignored, or not implemented. On the other hand, the mutual coupling or direct coupling or communication connection illustrated or discussed may be indirect coupling or communication connection through some interfaces, devices or units, which may be electrical, mechanical or other forms.

The units illustrated as separated components may or may not be physically separated, and components displayed as units may or may not be physical units. That is, they may be located in one place, or they may be distributed to multiple network units. A part or all of these units may be selected to fulfill the purpose of the present embodiments according to actual needs.

In addition, various functional units in various embodiments of the present disclosure may be integrated in a single processing unit, or various units may physically exist separately, or two or more units may be integrated in a single unit.

The above embodiments may be implemented in whole or in part by software, hardware, firm ware or any combination thereof. When implemented by software, they may be implemented in the form of computer program products in whole or in part. The computer program product includes one or more computer instructions. When the computer program instructions are loaded and executed on the computer, the flows or functions described in the embodiments of the present disclosure are generated in whole or in part. The computer may be a general purpose computer, a special purpose computer, a computer network, or other programmable devices. The computer instructions may be stored in a computer readable storage medium, or transferred from one computer readable storage medium to another computer readable storage medium. For example, the computer instructions may be transferred from a website site, a computer, a server or a data center to another website site, computer, server or data center through the wired manner (such as coaxial cable, optical fiber, digital subscriber line (DSL)) or the wireless manner (such as infrared, wireless, microwave, etc.). The computer readable storage medium may be any available medium that may be read by a computer or a data storage device including a server, a data center and the like containing one or more available medium integration. The available medium may be a magnetic medium (for example, floppy disk, hard disk, magnetic tape), an optical medium (for example, digital video disc (DVD)), or a semiconductor medium (for example, solid state disk (SSD), etc.

The above is only specific implementations of the present disclosure, but the scope of protection of the present disclosure is not limited to this. Any skilled person familiar with the technical field can easily think of changes or substitutions in the technical scope of the present disclosure, which should be covered by the scope of protection of the present disclosure. Therefore, the scope of protection of the present disclosure shall be based on the scope of protection of the claims.

1. A communication method, comprising:
transmitting, by a terminal device, a first message, the first message being used for a capability negotiation performed by the terminal device with a network device.

2. The method of claim 1, wherein the first message comprises at least one of:
a number of transmitting antennas expected to be retained by the terminal device, a number of receiving antennas expected to be retained by the terminal device, a number of transmitting antennas expected to be released by the terminal device, a number of receiving antennas expected to be released by the terminal device, a maximum number of carriers expected to be supported by the terminal device, or a maximum transmit power expected to be supported by the terminal device.

3. The method of claim 1, wherein the first message comprises a capability configuration requested by the terminal device from the network device.

4. The method of claim 1, wherein the first message is of any one of following message types:
radio resource control (RRC) message, media access control control element (MAC CE) message, or uplink control information (UCI) message.

5. A communication apparatus, comprising a transceiver, a memory and a processor, wherein the memory is configured to store programs, and the processor is configured to invoke the programs in the memory to control the communication apparatus to perform:
transmitting a first message, the first message being used for a capability negotiation performed by the apparatus with a network device.

6. The apparatus of claim 5, wherein the first message comprises at least one of:
a number of transmitting antennas expected to be retained by the apparatus, a number of receiving antennas expected to be retained by the apparatus, a number of transmitting antennas expected to be released by the apparatus, a number of receiving antennas expected to be released by the apparatus, a maximum number of carriers expected to be supported by the apparatus, or a maximum transmit power expected to be supported by the apparatus.

7. The apparatus of claim 5, wherein the first message comprises a capability configuration requested by the apparatus from the network device.

8. The apparatus of claim 5, wherein the first message is of any one of following message types:
radio resource control (RRC) message, media access control control element (MAC CE) message, or uplink control information (UCI) message.

9. The apparatus of claim 5, wherein the processor is further configured to invoke the programs in the memory to perform:
if the communication apparatus has not received a second message within a preset time period, autonomously determining a set of capability configurations,
wherein the second message comprises:
a capability configuration determined by the network device for the apparatus and/or indication information that content requested in the first message is accepted by the network device.

10. The apparatus of claim 9, wherein the preset time period is configured through at least one of following manners:
pre-configuration, system broadcast message configuration or dedicated signaling configuration.

11. The apparatus of claim 7, wherein the capability configuration comprises at least one of:
a number of transmitting antennas of the apparatus, a number of receiving antennas of the apparatus, a maximum number of carriers supported by the apparatus, a maximum bandwidth supported by the apparatus, a dual connectivity (DC) capability of the apparatus, a carrier aggregation (CA) capability of the apparatus, a maximum number of multi input multi output (MIMO) system layers supported by the apparatus, or a maximum transmit power supported by the apparatus.

12. The apparatus of claim 5, wherein the processor is further configured to invoke the programs in the memory to control the communication apparatus to perform:
receiving a fourth message, the fourth message being used for indicating that the network device allows the apparatus to perform the capability negotiation.

13. The apparatus of claim 12, wherein the fourth message further comprises a configuration of a timer for prohibiting frequent request, and the apparatus is not allowed to request the network device for the capability negotiation through the first message during an operation of the timer for prohibiting the frequent request.

14. A communication apparatus, comprising a transceiver, a memory and a processor, wherein the memory is configured to store programs, and the processor is configured to invoke the programs in the memory to control the communication apparatus to perform:
receiving a first message, the first message being used for a capability negotiation performed by a terminal device with the apparatus.

15. The apparatus of claim 14, wherein the first message comprises at least one of:
a number of transmitting antennas expected to be retained by the terminal device, a number of receiving antennas expected to be retained by the terminal device, a number of transmitting antennas expected to be released by the terminal device, a number of receiving antennas expected to be released by the terminal device, a maximum number of carriers expected to be supported by the terminal device, or a maximum transmit power expected to be supported by the terminal device.

16. The apparatus of claim 14, wherein the first message comprises a capability configuration requested by the terminal device from the apparatus.

17. The apparatus of claim 14, wherein the first message is of any one of following message types:
radio resource control (RRC) message, media access control control element (MAC CE) message, or uplink control information (UCI) message.

18. The apparatus of claim 16, wherein the capability configuration comprises at least one of:
a number of transmitting antennas of the terminal device, a number of receiving antennas of the terminal device, a maximum number of carriers supported by the terminal device, a maximum bandwidth supported by the terminal device, a dual connectivity (DC) capability of the terminal device, a carrier aggregation (CA) capability of the terminal device, a maximum number of multi input multi output (MIMO) system layers supported by the terminal device, or a maximum transmit power supported by the terminal device.

19. The apparatus of claim 14, wherein the processor is further configured to invoke the programs in the memory to control the communication apparatus to perform: transmitting a fourth message, the fourth message being used for indicating that the apparatus allows the terminal device to perform the capability negotiation.

20. The apparatus of claim 19, wherein the fourth message further comprises a configuration of a timer for prohibiting frequent request, and the terminal device is not allowed to request the apparatus for the capability negotiation through the first message during an operation of the timer for prohibiting the frequent request.
